(19) United States
(12) Patent Application Publication
(10) Pub. No.: US 2016/0290505 A1
(43) Pub. Date: Oct. 6, 2016

(54) CYLINDER-PISTON ASSEMBLY

(71) Applicant: CATERPILLAR INC., PEORIA, IL (US)

(72) Inventors: JEREMY TODD PETERSON, WASHINGTON, IL (US); JEFFREY LEE KUEHN, GERMANTOWN HILLS, IL (US); VIRAL S. MEHTA, PEORIA, IL (US); NOAH DENVER MANRING, COLUMBIA, MO (US); ROGER CLAYTON FALES, STURGEON, MO (US)

(73) Assignee: CATERPILLAR INC., PEORIA, IL (US)

(21) Appl. No.: 15/182,110

(22) Filed: Jun. 14, 2016

(51) Int. Cl. F16J 1/00; F16J 10/02

(52) U.S. Cl. CPC F16J 1/005; F16J 10/02

(57) ABSTRACT

A cylinder-piston assembly includes a cylinder barrel having a first end and a second end. An end cap is coupled to the cylinder barrel at the first end having a cylindrical opening. A piston slidably disposed in the cylinder barrel has a piston rod connected to the piston. The piston rod passes through the cylindrical opening of the end cap. A spring is disposed circumferentially around the piston rod. A load cell disposed in the end cap is adapted to generate a signal indicative of the cylinder displacement based on a spring force exerted on the load cell during a movement of the piston in the cylinder barrel, wherein the load cell is pressure balanced to minimize effect of forces other than the spring force exerted on the load cell.

### TECHNICAL FIELD

The present disclosure relates to a cylinder-piston assembly. More specifically, the present disclosure relates to determine a cylinder displacement of the cylinder-piston assembly.

### BACKGROUND

Various types of machines, such as a wheel loader, an excavator, a dozer, and the like are used for a number of industrial applications such as construction, forestry, agriculture, mining and excavation. Generally, such machines include an implement through which a particular operation is carried out. For example, an excavator may include a boom attached to a frame of the excavator. The boom supports an arm connected to a bucket. The excavator may include individual hydraulic/pneumatic means to actuate the boom, the arm and the bucket. Hydraulic/pneumatic means may be a cylinder-piston assembly adapted to provide required motive force to the corresponding parts. An operator may control operation of the bucket by controlling a position of the cylinder-piston assemblies associated with various parts.

Currently, various kinds of sensors, such as linear displacement transducers (LDT), magnetostrictive sensors, electromagnetic sensors, can be used as position sensing devices. However, devices to measure absolute cylinder displacement in harsh environments with a high degree of reliability is presently complex and expensive.

D.E. Publication Number 10,2005,057,914 describes a hydraulic or pneumatic actuator. The actuator has a mechanical drift element movable inside a housing under hydraulic/pneumatic force. A spring biases the mechanical drift element in a relaxed position. A force sensor arranged between the spring and the mechanical drift element detects the force experienced by the spring. However, as the force sensor is arranged between the spring and the mechanical drift element, the force sensor is susceptible to various other forces as well and may not provide an accurate estimate of the forces acting on the spring and hence, the cylinder displacement.

### SUMMARY

In an aspect of the present disclosure, a cylinder-piston assembly includes a cylinder barrel having a first end and a second end. An end cap is coupled to the cylinder barrel at the first end. The end cap has a cylindrical opening. A piston is slidably disposed in the cylinder barrel. The piston has a piston rod connected to the piston. The piston rod passes through the cylindrical opening of the end cap. A spring is disposed circumferentially around the piston rod. A load cell disposed in the end cap is adapted to generate a signal indicative of the cylinder displacement based on a spring force exerted on the load cell during a movement of the piston in the cylinder barrel. The load cell is pressure balanced to minimize effect of forces other than the spring force exerted on the load cell.

### BRIEF DESCRIPTION OF DRAWINGS

FIG. 1 schematically illustrates a cylinder-piston assembly including a spring and a load cell, in accordance with an embodiment of the present disclosure; and

FIG. 2 schematically illustrates the cylinder-piston assembly of FIG. 1, wherein the spring is a tapered spring, in accordance with another embodiment of the present disclosure.

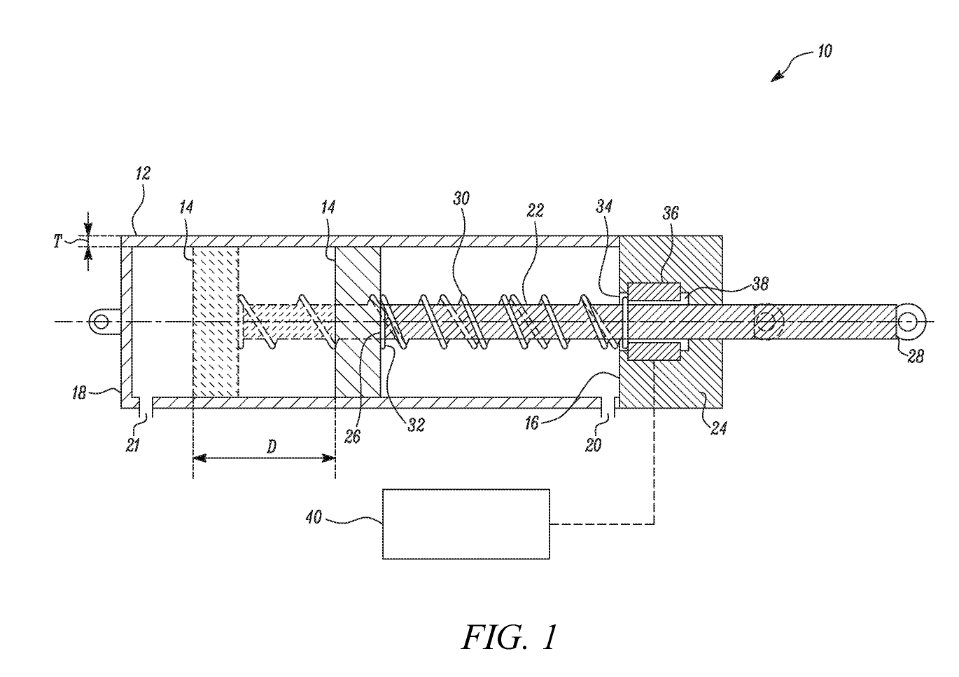

### DETAILED DESCRIPTION

Wherever possible, the same reference numbers will he used throughout the drawings to refer to same or like parts. Construction machines such as an excavator include an implement such as a bucket to manipulate a ground surface. Generally, the excavator controls the bucket through a hydraulic/pneumatic actuator. The hydraulic/pneumatic actuator may be a cylinder-piston assembly. FIG. 1 illustrates a cylinder-piston assembly 10 in accordance with an embodiment of the present disclosure. The cylinder-piston assembly 10 may be used to control movement of an implement of a machine (not shown). The cylinder-piston assembly 10 may also be used to control movement of various other parts of the machine as well. The machine may be used in various industries and application areas such as construction, forestry, agriculture, mining, excavation etc.

As shown in FIG. 1, the cylinder-piston assembly 10 includes a cylinder barrel 12. The cylinder barrel 12 is a hollow cylindrical shaped body having a thickness ‘T’. The cylinder barrel 12 may be made up of any metallic material suitable to the scope of the present disclosure. A piston 14 is located in the cylinder barrel 12 which can slideably reciprocate inside the cylinder barrel 12 between a first end 16 and a second end 18. The piston 14 may slide inside the cylinder barrel 12 due to a hydraulic or a pneumatic force. The cylinder barrel 12 has a first port 20 and a second port 21 to provide supply and withdrawal of hydraulic/pneumatic fluid to the cylinder barrel 12 respectively. The cylinder barrel 12 may also include stoppers (not shown) on the first and second ends 16, 18 to limit the sliding movement of the piston 14 inside the cylinder barrel 12 and avoid contacting the first and second ends 16, 18. The piston 14 may slide in the cylinder barrel 12 between the first and second ends 16, 18 based on the supply/withdrawal of hydraulic/pneumatic fluid as per the requirement of a particular application.

The piston 14 may be made up of a suitable metallic material such as a cast aluminum alloy, suitable to the scope of the present disclosure. The piston 14 is connected to a piston rod 22 that extends outwards from the cylinder barrel 12 from the first end 16. The piston 14 may be connected to the piston rod 22 by a mechanical connection such as welding, brazing, adhesive means or a mechanical fastener. The piston 14 and the piston rod 22 may also be casted as a single piece.

As shown in FIG. 1, an end cap 24 is attached to the first end 16 of the cylinder barrel 12. The end cap 24 may be attached to the first end 16 of the cylinder barrel 12 by any mechanical joining process such as welding, brazing, mechanical fasteners etc. A seal (not shown) may be attached between the first end 16 of the cylinder barrel 12 and the end cap 24. The seal may prevent leakage of any hydraulic fluid around the first end 16 along the piston rod 22. The seal may be attached to either of the piston rod 22 or the end cap 24. The end cap 24 is a metal part having a cylindrical opening to allow the piston rod 22 to pass through. The piston rod 22 has a first end 26 connected to the piston 14 and a second end 28 which may have means to be connected to an implement of a machine or any other part of the machine according to the need of the application. As illustrated, the piston rod 22 is partially enclosed inside the cylinder barrel 12 and partially extends outside the cylinder barrel 12.

A spring 30 is circumferentially located on the piston rod 22 inside the cylinder barrel 12. The piston rod 22 acts as a guide to the spring 30. The spring 30 may he any type of a spring such as tapered spring, disc spring etc. in accordance with the present disclosure. In an embodiment, the spring 30 may be an elastomer spring as well. The spring 30 is adapted to be compressed or extended as the piston 14 and the piston rod 22 slide inside the cylinder barrel 12. The spring 30 may have a first end 32 attached to the first end 26 of the piston rod 22 and a second end 34 attached to aloud cell 36 attached to the end cap 24.

The load cell 36 is typically a transducer used to create an electrical signal having a magnitude directly proportional to a force being measured. The load cell 36 may be a hydraulic load cell, a pneumatic load cell, or a strain gauge load cell. The load cell 36 may be of any shape such as a cylindrical shape, a circular shape, a fiat plate shape etc. in accordance with the present disclosure. In an embodiment, the load cell 36 is of a hollow cylindrical shape. The load cell 36 is attached to the end cap 24. The end cap 24 may have an opening 38 concentric to the cylindrical opening in the end cap 24. The load cell 36 may be accommodated in the opening 38 such that some part of the load cell 36 is in contact with the second end 34 of the spring 30. The load cell 36 may also be arranged in the end cap 24 in any other suitable way in accordance with the present disclosure.

As the spring 30 compresses or extends, the spring 30 applies a spring force F on the load cell 36. As the pressurized hydraulic fluid flows around the load cell 36 in the end cap 24, the load cell 36 experiences force due to the pressurized hydraulic fluid from all sides. Thus, the load cell 36 is in a pressure balanced condition with respect to the hydraulic forces acting on the load cell 36 as the hydraulic forces tend to cancel each other out. Further, as the spring 30 is also applying the spring force F on the load cell 36, the load cell 36 generates a signal indicative of the forces exerted on the load cell 36. The spring force F constitutes a major part of this signal along with minimal contribution from other forces.

As shown in FIG, 1, the piston 14 and piston rod 22 are shown in two positions, where a first position is represented by solid lines and a second position is represented by dotted lines. The first and second positions are spaced apart by a displacement ‘D’. Generally, a cylinder displacement refers to the relative position of the piston 14 with respect to the cylinder barrel 12, which may be defined by knowing the displacement ‘D’. For the sake of explanation, let us assume that the spring 30 is in a natural state i.e. a state of no compression or extension corresponding to the first position of the piston 14 and the piston rod 22. The spring 30 experiences no force in the natural state. As the piston 14 and the piston rod 22 are displaced by a displacement ‘D’ and come to the second position, the spring 30 also extends by a length ‘D’ as the spring 30 is connected to the first end 26 of the piston rod 22. The spring 30 experiences a force F which is a function of the displacement length ‘D’, such that F=f(D). The function f(D) defines a relationship between the displacement D and the force F. in an embodiment, the function f(D) may define a linear relationship between the displacement D and the force F. The function f(D) may define a non-linear relationship as well between the displacement D and the force F suitable to the scope of the present disclosure.

The spring 30 exerts a pressure corresponding to the spring force on the load cell 36 as the spring 30 is attached to the load cell 36 at the second end 34. In another embodiment, the second end 34 of the spring 30 may be attached to a plate (not shown) which may further be attached to the load cell 36. The spring 30 may apply force on the plate and the plate may exert a uniform pressure on the load cell 36. The load cell 36 generates a signal indicative of the force F exerted by the spring 30 which may be processed to calculate a corresponding force signal.

A controller 40 is attached to the load cell 36 which receives the signal corresponding to the pressure exerted by the spring 30 on the load cell 36. The controller 40 may be an Electronic Control Unit (ECU) of the machine. The controller 40 may have means to convert the signal received from the load cell 36 to a value corresponding to the force F. The controller 40 may have the function f(D) stored in memory so that the controller 40 can calculate the value of the force F based on the value of the displacement D. The signal may be an electrical signal in form of an electrical current/voltage. The controller 40 may have a look up table so as to convert the electrical current/voltage into the value of the force. The look up table may also contain information relating to the functional relationship f(D) between the force F and the displacement D. The look up table may relate value of displacement D to the current/voltage value produced by the load cell 36. The controller 40 may have any such means to derive the value of the force from the signal generated by the load cell 36.

The controller 40 may further have means to calculate the cylinder displacement D. As the spring force F is a function of displacement D, by knowing the value of force F as well as the relationship f(D) between the spring force F and the displacement D, cylinder displacement can be calculated.

Although, the spring 30 is shown in an extended state when the piston 14 and the piston rod 22 are in the second position, it should be contemplated that the second position of the piston 14 and the piston rod 22 can also be such that the spring 30 is compressed. In an embodiment, the spring 30 may be pre-stressed corresponding to the first position of the piston 14 and the piston rod 22 so that the spring 30 extends when the piston 14 and the piston rod 22 move from the first position to the second position. In such as case, the spring 30 will exert pressure on the load cell 36 in the natural state. Further, as the piston 14 and the piston rod 22 move from the first position towards the second position, the spring 30 will exert lesser pressure on the load cell 36 compared to the pressure exerted at the natural state. A difference between the two pressure values will provide the pressure applied on the load cell 36 due to the displacement of the piston 14 and the piston rod 22. Thus, the force applied by the spring 30 on the load cell and the corresponding cylinder displacement can be calculated.

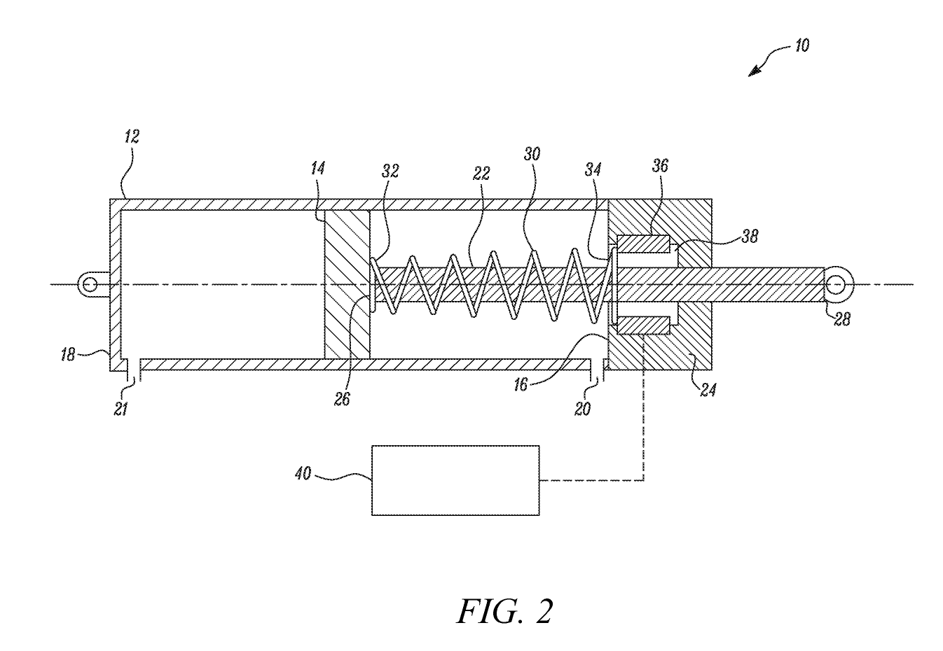

FIG. 2 illustrates another embodiment of the present disclosure. In this embodiment, the spring 30 is a tapered spring. The diameter of the spring 30 increases from the first end 32 towards the second end 34. Therefore, when the spring 30 is in a fully compressed state, the spring 30 would collapse on itself such as to minimize the space taken by the spring 30.

### INDUSTRIAL APPLICATION

Construction or earth-moving machines may use various software algorithms embodied in a processor to control the machine autonomously or semi-autonomously. Such software algorithms may control a machine such as an excavator to automatically excavate a surface or a motor grader to automatically impart a desired grade to a surface etc. Implements of such machines are provided with commands so as to control the machine autonomously. The implement of the machine is controlled by a cylinder-piston assembly actuated by hydraulic/pneumatic means. With the autonomous control software in place, it becomes vital to know cylinder displacement exactly so as to provide accurate control commands to the machine.

The present disclosure provides a solution determining the cylinder displacement. The cylinder-piston assembly 10 includes the piston 14 and the piston rod 22 which reciprocate inside the cylinder barrel 12. Hydraulic/pneumatic fluid may enter/exit through the ports 20, 21 to make the piston 14 and the piston rod 22 slide between the first and second ends 16, 18 of the cylinder barrel 12. For example, when the hydraulic/pneumatic fluid is supplied through the port 20 and/or the hydraulic/pneumatic fluid is withdrawn from the port 21, the piston 14 experiences a force due to motion of the fluid and slides from the first end 16 towards the second end 18 of the cylinder barrel 12. Alternatively, when the hydraulic/pneumatic fluid is supplied through the second port 21 and/or withdrawn from the first port 20, the piston 14 slides from the second end 18 towards the first end 16 of the cylinder barrel 12.

The cylinder-piston assembly 10 includes the spring 30 circumferentially attached to the piston rod 22. The first end 32 of the spring 30 is attached to the first end 26 of the piston rod 22 and the second end 34 of the spring 30 is attached to the load cell 36 attached to the end cap 24. As the piston 14 slides inside the cylinder barrel 12, the spring 30 exerts force on the load cell 36. The load cell 36 generates the signal corresponding to the spring force and the displacement of the piston 14 relative to the cylinder barrel 12 can be calculated knowing the spring force F and the functional relationship f(D) between the spring force F and the displacement D.

Also, as only the spring 30 and the load cell 36 are the additional components required, the cylinder-piston assembly 10 is fairly simple in construction and does not take extensive time in service and maintenance. Further, the load cell 36 is installed in the pressure balanced condition, therefore allowing the spring 30 being used to be of a low spring force sensitivity. This minimizes the working load on the cylinder-piston assembly 10 as the spring 30 poses no restrictions in functioning of the cylinder-piston assembly 10.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A cylinder-piston assembly comprising:
a cylinder barrel having a first end and a second end;
an end cap coupled to the cylinder barrel at the first end, the end cap having a cylindrical opening;
a piston slidably disposed in the cylinder barrel, the piston having a piston rod connected to the piston, wherein the piston rod passes through the cylindrical opening of the end cap;
a spring disposed circumferentially around the piston rod; and
a load cell disposed in the end cap and adapted to generate a signal indicative of the cylinder displacement based on a spring force exerted on the load cell during a movement of the piston in the cylinder barrel, wherein the load cell is pressure balanced to minimize effect of forces other than the spring force exerted on the load cell.

2. The cylinder-piston assembly of claim 1, wherein the spring is a tapered spring.

3. The cylinder-piston assembly of claim 1, wherein the cylinder-piston assembly is actuated by one of a hydraulic means or a pneumatic means.
